(19) United States
(12) Patent Application Publication
(10) Pub. No.: US 2024/0415616 A1
(43) Pub. Date: Dec. 19, 2024

(54) Dental Scan Body Having Rectangular Block Shape

(71) Applicant: Jun Hyun Park, Chantilly, VA (US)

(72) Inventor: Jun Hyun Park, Chantilly, VA (US)

(21) Appl. No.: 18/734,784

(22) Filed: Jun. 5, 2024

Related U.S. Application Data
(60) Provisional application No. 63/507,933, filed on Jun. 13, 2023.

(51) Int. Cl. A61C 9/00; A61C 8/00; A61C 13/34

(52) U.S. Cl. CPC A61C 9/0053; A61C 8/005; A61C 8/0089; A61C 13/34

(57) ABSTRACT

A dental implant scan body comprising a rectangular block having a substantially rectangular shape. A tool channel travels through the rectangular block. A base adaptor is at the bottom of the rectangular block. The base adaptor is configured to dock with an underlying mounting platform that supports the dental prosthesis. There is a first recess on the fore section of the rectangular block and a second recess on the aft section. For example, there could be a notch on the fore section and two trenches on the aft section. The rectangular block could have bevel edges at the top surface. Also disclosed are intraoral scanning methods that use the scan bodies and dental kits that contain the scan bodies.

### TECHNICAL FIELD

This invention relates to fabricating custom dental prosthesis.

### BACKGROUND

In the modern practice of dental prosthodontics, digital 3D models of patients oral cavities are used to fabricate custom dental prosthetics. One way of acquiring a topographic rendering of the inside of the patient's mouth is performing intraoral scanning with an intraoral scanning probe. This creates an intraoral topographic impression. Represented in this digital impression are the dental, palatal, alveolar, and oral cavity structures. Also represented in this digital impression are the dental implants.

During intraoral scanning, multiple separate but overlapping images of different parts of the mouth are acquired. These multiple overlapping images are combined into a single panorama image through a process called “image stitching”. This stitching process relies on correct matching of overlapping areas among the multiple separate images. To improve image stitching, scan bodies may have conspicuous side planes that help the image processing operation find keypoints for feature matching. However, to capture these side planes, the user often must tilt the scanning probe from the sides or back of the mouth. Doing this maneuver can be inconvenient and fail to adequately capture the side planes. This can result in poor quality stitching. For example, poorly quality stitching can result in a warped panorama image that is not representative of the true geometry and positioning of the multiple implants.

FIG. 1 (prior art) shows an example of a conventional scan body 10 installed on a dental implant. The tooth implant shown here comprises an implant fixture 14 that is embedded into the jaw bone 16 at the position of the missing tooth. For purpose of intraoral scanning, a scan body 10 is seated onto the implant fixture 14. See that scan body 10 has several flat faces 12. These are to help with image stitching as explained above. Also shown here are some native teeth 18.

### SUMMARY

This invention encompasses dental implant scan bodies, methods for performing intraoral scanning on a patient, implant scan body kits, etc. Implant Scan Body. In one aspect, this invention is a dental implant scan body comprising a rectangular block having a substantially rectangular shape. The term “rectangular shape” means the silhouette shape as viewed from top down. The rectangular block could have any suitable dimensions. For example, the length of the rectangular block could be at least 10 mm, and optionally, in the range of 10-30 mm. In another example, the width of the rectangular block could be at most 12 mm, and optionally, in the range of 3.0-12 mm. In another example, the height of the rectangular block could be at most 10 mm, and optionally, in the range of 2.0-10 mm. The length-width ratio could vary. For example, the length could be at least 1.5 times the width; in some cases, at least 2.2 times the width; and optionally, at most 6.0 times the width.

There is a tool channel in the rectangular block and a channel port at the top of the rectangular block. There may be a collar around the channel port. The height of the collar could be selected to help in blocking the flow of resin into the channel port. For example, the height of the collar could be at least 0.3 mm, and in some cases, at least 0.5 mm; and optionally, at most 2.5 mm. A base adaptor is at the bottom of the rectangular block. The base adaptor is configured to dock with an underlying mounting platform that supports the dental prosthesis. As such, the configuration of the base adaptor will vary according to the different mounting platforms with which it mates, such as variations in shape, size, connection, etc.

The rectangular block comprises a fore section and an aft section, as partitioned by the channel port. The terms “fore/aft” and “left/right” are arbitrary labels to designate orientation and are for illustration purposes only to facilitate easy understanding. There is a first recess on the fore section and a second recess on the aft section. The rectangular block could have multiple (two or more) first or second recesses. Examples of “recess” include divot, pocket, groove, cutout, cleft, pit, dent, fissure, rift, hole, trench, notch, etc. The rectangular block at the fore section and aft section could be asymmetric. This asymmetric configuration could be useful for increasing feature variation that improves the image stitching results.

The rectangular block comprises multiple (two or more) bevel edges at the top surface. For example, the rectangular block could have at least 5 bevel edges at the top surface, and optionally, at most 15 bevel edges. In some designs, every edge at the top surface perimeter of the rectangular block is a bevel edge.

The scan body could be made of any suitable material such as metal (e.g. titanium, aluminum, stainless steel), hard plastic, etc. The scan body could be made of multiple materials. For example, different parts of the scan body could be made of different materials.

Intraoral Scanning Method. In another aspect, this invention is a method of performing intraoral scanning on a patient to acquire a digital intraoral topographic impression. The method uses multiple scan bodies of this invention. Perform a dental treatment procedure of putting multiple mounting platforms on a jaw of the patient (such as embedding implant fixtures, affixing implant abutments to the fixtures, or both). Install the scan bodies on the mounting platforms (e.g. implant abutment or implant fixture). Perform intraoral optical scanning to capture images of the oral cavity including the scan bodies. Create a digital topographic impression using the captured images. This process may involve stitching the captured images together (e.g. into a composite portrait).

The step of installing the scan bodies could comprise one or more of the following actions. Insert a fastening screw into the tool channel for the scan body. Engage the base adaptor of the scan body to the mounting platform. Insert a driver tool into the tool channel. Use the driver tool to fasten the fastening screw to the mounting platform. This is performed for each of the scan bodies.

The method may further comprise making a physical master model for the patient's implants. This may involve one or more of the following steps. Join the multiple scan bodies into a linked assembly using an adhesive resin material. This could be performed by applying the resin onto the scan bodies with bridge portions between adjacent scan bodies. These harden into one or more resin patches that link the scan bodies together. Examples of adhesive resin material that could be used include materials that comprise acrylates, epoxides, dental composite resins, etc. Remove the linked assembly from the patient's mouth. This could be performed by loosening the fastening screws that attach the scan bodies to the mounting platforms. Insert implant analogs into each of the tool channels of the scan bodies. Lay the linked assembly onto a plaster slab. The plaster slab could be made from any suitable plaster casting material such as mixed dental cement, acrylic resin, composite resin, dental stone, etc. Plant the implant analogs into the plaster slab. Remove the linked assembly but leave the implant analogs planted in the plaster slab.

Along with the digital 3D model, this physical master model (implant analogs fixed in hardened plaster slab) may then be sent to a fabrication facility for making the custom prosthesis. Examples of dental prosthesis for the implant include crowns, bridges, dentures, or other appliances used in dental restoration. For a physical master model made using a linked assembly, this invention may be particularly useful for multi-unit prosthesis (such as bridges or dentures). In some embodiments, the prosthesis is not a crown.

Implant Scan Body Kit. In another aspect, this invention is a dental scan body kit comprising multiple (two or more) scan bodies as described herein. The kit further comprises multiple fastening screws for the scan bodies and a driver tool for the fastening screws. In this kit, the components are provided together in the same package. The kit may further comprise one or more of the following: a dispenser (e.g. syringe, squeeze tube, etc.) containing an adhesive resin material, multiple implant analogs that slide into the tool channel of the scan bodies, a plaster casting material for making a plaster slab, a casting setup tray into which the wet plaster casting material is poured to make the plaster slab. Optionally, the kit may further comprise one or more connector beams. In some embodiments, the connector beam has through-holes of multiple (two or more) different shapes.

### BRIEF DESCRIPTION OF THE DRAWINGS

FIG. 1 (prior art) shows an example of a conventional scan body.

FIGS. 2A-2C show various perspective views of an example scan body of this invention. FIG. 2A shows a view from the aft side; FIG. 2B shows a view from the fore side; FIG. 2C shows a view from the bottom side.

FIGS. 3A-3C show various internal see-through views of the scan body. FIG. 3A shows a perspective view; FIG. 3B shows a side view; FIG. 3C shows an end view. FIG. 3D shows a top view of the scan body.

FIGS. 4A and 4B show how the scan body is mounted onto the abutments in the patient's jaw. FIG. 4A shows a fastening screw in the tool channel. FIG. 4B shows a driver tool inserted into the tool channel to engage with the screw.

FIG. 5 shows scan bodies mounted onto their respective abutments that are affixed on the lower jaw of the patient.

FIGS. 6A-6C demonstrate how the scan body linked assembly is made. FIG. 6A shows dental resin applied onto the scan bodies to link them together. FIG. 6B shows the linked assembly laid onto dental stone. FIG. 6C shows the linked assembly lifted off the stone slab.

FIGS. 7A and 7B show an example of a connector beam and how it could be used during intraoral scanning. FIG. 7A shows a perspective view of the connector beam. FIG. 7B shows the connector beam used to bridge a gap between scan bodies.

FIG. 8 shows an example of a scan body kit of this invention.

FIGS. 9A and 9B show another example of a scan body. FIG. 9A shows a top view. FIG. 9B shows a perspective view.

FIGS. 10A and 10B show another example of a connector beam. FIG. 10A shows a top view. FIG. 10B shows a perspective view.

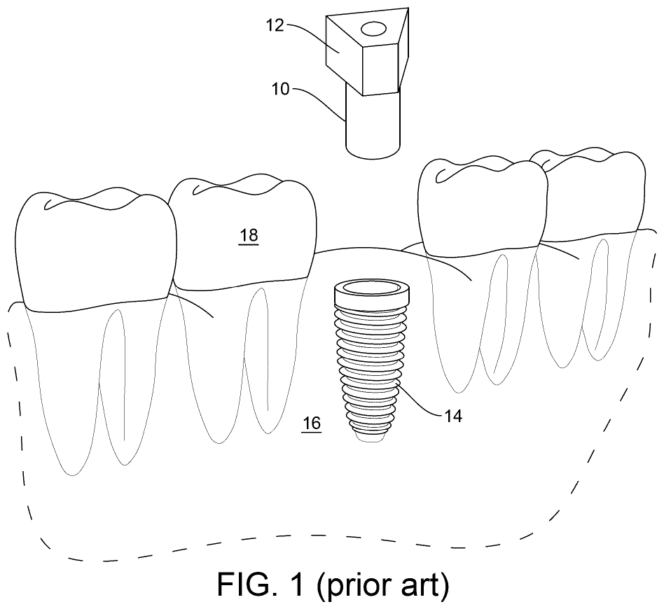

### DETAILED DESCRIPTION OF EXAMPLE EMBODIMENTS

To assist in understanding the invention, reference is made to the accompanying drawings to show by way of illustration specific embodiments in which the invention may be practiced. The drawings herein are not necessarily made to scale or actual proportions. For example, lengths and widths of the components may be adjusted to accommodate the page size.

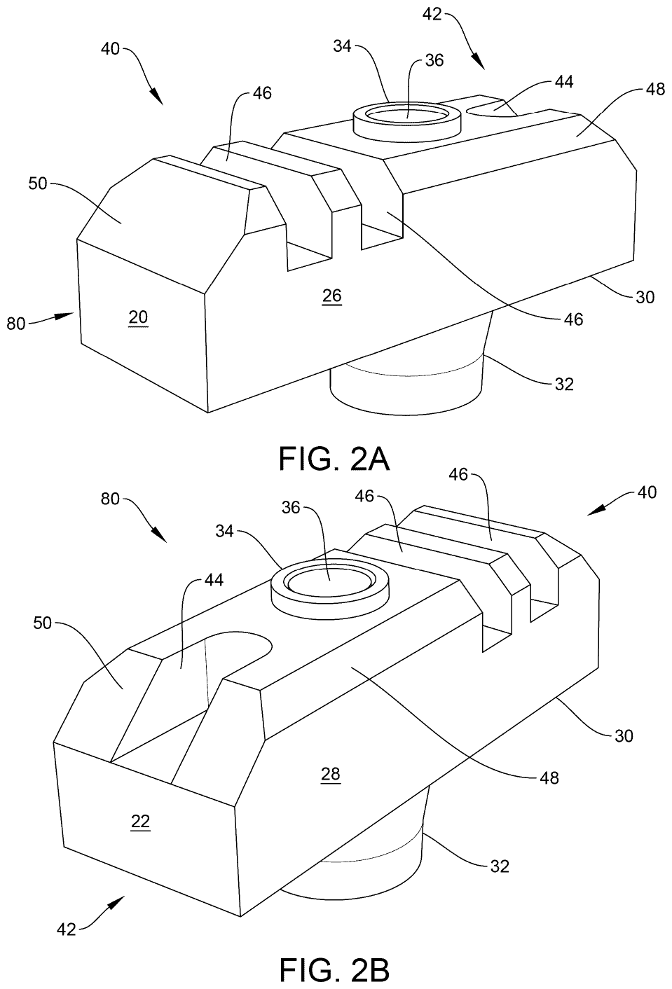

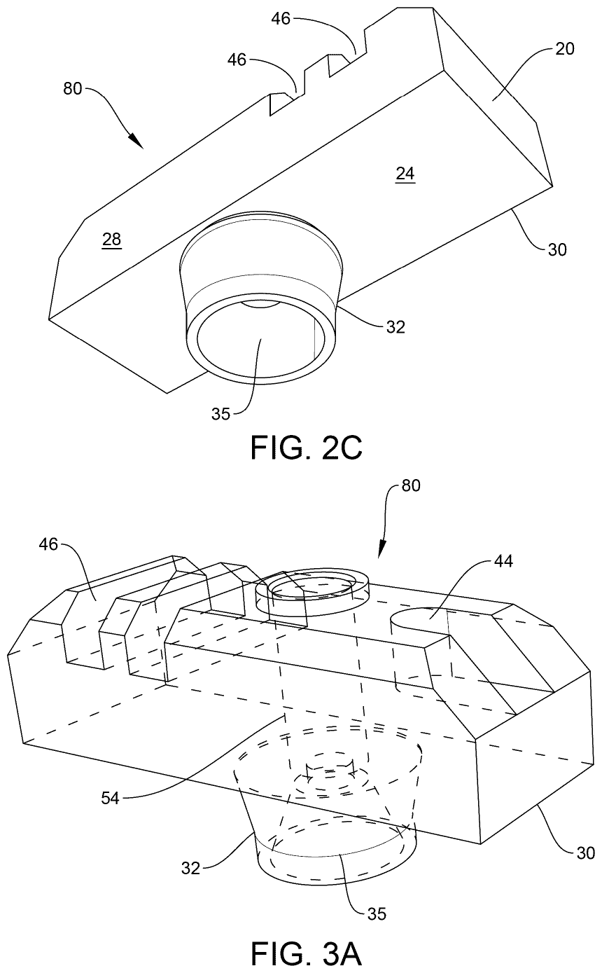

FIGS. 2A-2C show various perspective views of an example scan body 80 of this invention. Scan body 80 has a generally rectangular shape. FIG. 2A shows a view from the aft side 20 and right side 26; FIG. 2B shows a view from the fore side 22 and left side 28; FIG. 2C shows a view from the bottom side 24 and left side 28. Scan body 80 is made of stainless steel, and comprises a rectangular block 30 and a base adaptor 32. On the top surface of rectangular block 30, there is a collar 34 that makes a ring around a channel port 36. This collar 34 may be useful to block the flow of resin into the channel port 36 (see explanation below). Scan body 80 has an asymmetrical configuration and channel port 36 can serve as a reference partition for defining the different features of scan body 80. There is an aft section 40 of rectangular block 30 and crossing over channel port 36, there is a fore section 42 of rectangular block 30.

On fore section 42 of rectangular block 30, there is a notch 44 that is oriented in a longitudinal direction (i.e. along the longitudinal axis of scan body 80). On aft section 40 of rectangular block 30, there are two trenches 46 oriented in a transverse direction (i.e. parallel to the transverse axis of scan body 80). The two trenches 46 are also oriented parallel to each other. The bottom view in FIG. 2C shows a base adaptor 32 and a socket 35 for receiving the head of the implant abutment (not shown here, see further explanation below).

There are also multiple bevel edges on rectangular block 30 (total of nine). At the left and right side corners at the top surface of rectangular block 30, there are bevel edges 48 on each side. Likewise, at the fore and aft corners at the top surface of rectangular block 30, there are bevel edges 50 at each end. These bevel edges 48, 50 create additional flat faces on rectangular block 30 that may be useful for giving the image processing operation more image features that help with feature matching. By having these multiple bevel edges on different parts of rectangular block 30 and facing different directions, the user can also avoid or reduce the extra maneuvers needed to capture additional object features for imaging stitching.

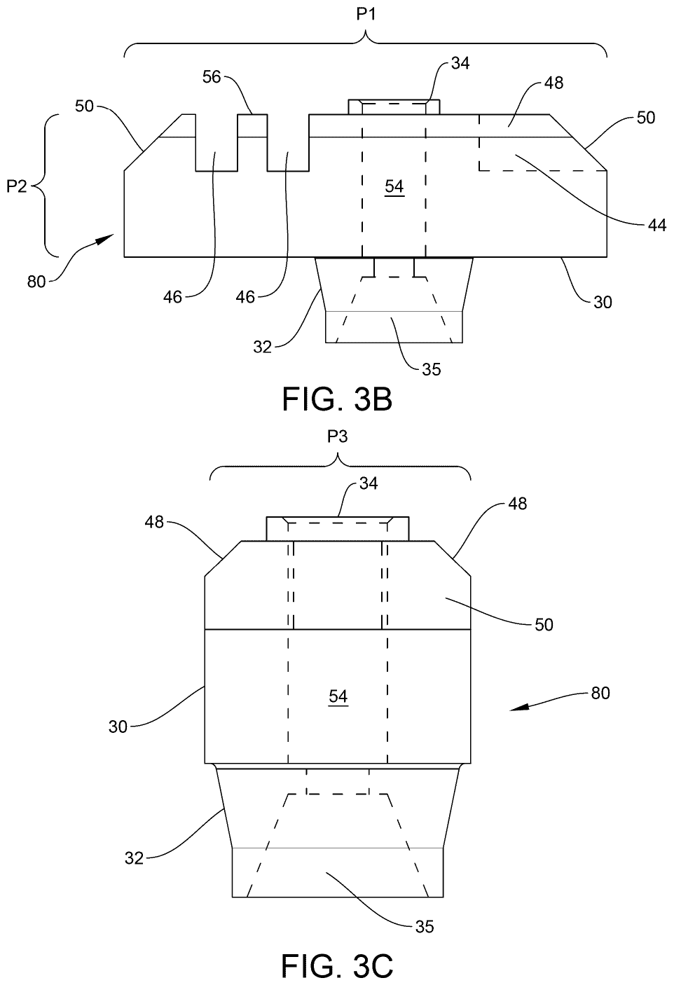

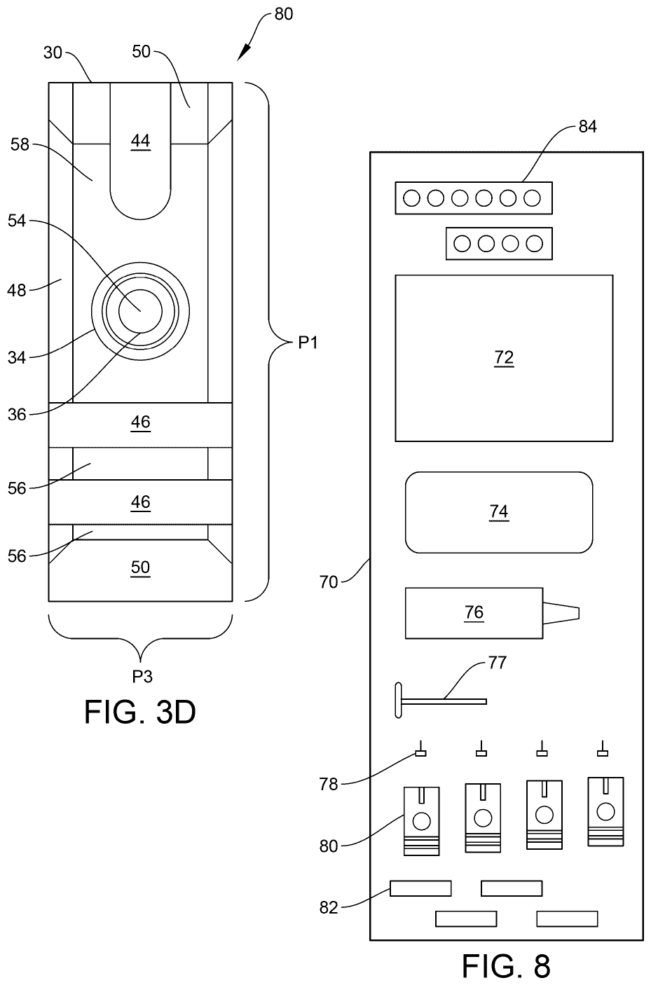

FIGS. 3A-3C show various internal see-through views of scan body 30. FIG. 3A shows a perspective view; FIG. 3B shows a side view; FIG. 3C shows an end view. In particular, these views show a tool channel 54 that travels through rectangular block 30. These also show the various dimensions of this scan body 80. As shown in FIG. 3B, the overall length P1 of rectangular body 30 is 17.0 mm. The overall height P2 of rectangular block 30 is 5.0 mm (and 5.5 mm if including the collar). The height of collar 34 is 0.5 mm. FIG. 3B also shows how trenches 46 create a ridge 56 that juts upward.

As shown in FIG. 3C (end view), the overall width P3 of rectangular block 30 is 6.0 mm. FIG. 3D shows a top view of scan body 80 and demonstrates the silhouette profile (top down) of rectangular block 30 that defines the rectangular shape. Repeating the prior passage, the overall length P1 of rectangular block 30 is 17.0 mm and the overall width P3 of rectangular block 30 is 6.0 mm. The length is about 2.8 times the width. FIG. 3D also shows how notch 44 creates a rim 58 around thereof.

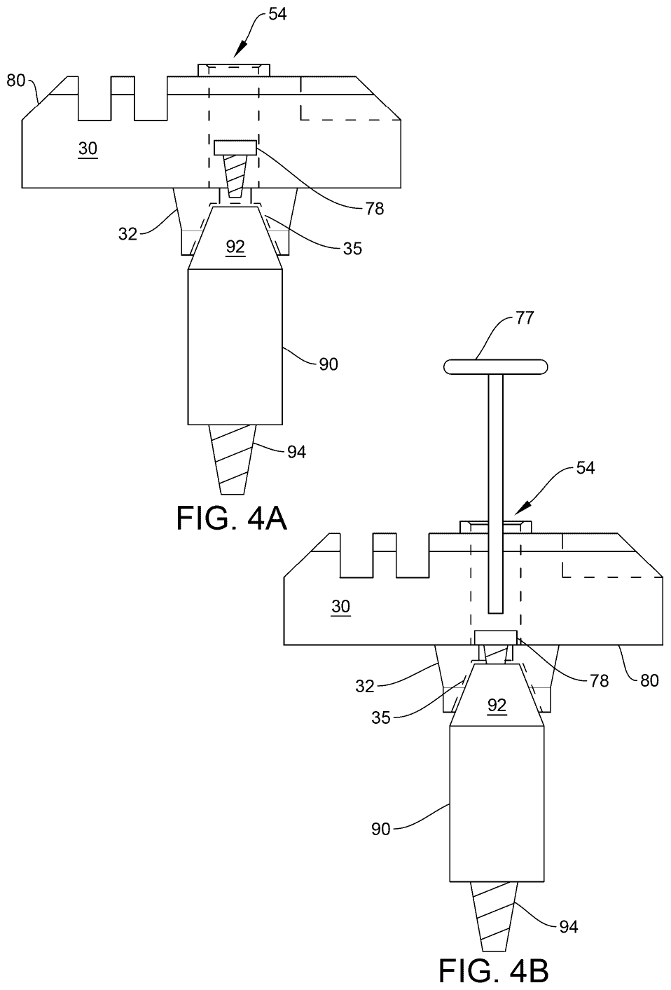

FIGS. 4A and 4B show how scan body 80 is mounted onto an abutment 90 in the patient's jaw (not shown). These show the see-through side view of scan body 80 as previously shown in FIG. 3B above. Abutment 90 is mounted onto an underlying implant fixture (not shown) via a tail screw 94 on abutment 90. The implant fixture is already embedded into the patient's jaw. Scan body 80 is positioned so that the head 92 of abutment 90 is docked into the socket 35 of base adaptor 32 at the bottom of scan body 80. As shown in FIG. 4A, a fastening screw 78 is dropped through the channel port and into the tool channel 54 of rectangular block 30 of scan body 80. This positions fastening screw 78 at the top of head 92 of abutment 90, which has a counterpart receiving hole for screw 78. There is a screw hole that connects tool channel 54 to socket 35. As shown in FIG. 4B, a driver tool 77 is inserted into channel port and advanced through tool channel 54 to engage with screw 78. Using driver tool 77, screw 78 is tightened onto head 92 of abutment 90. This fastening joins scan body 80 to abutment 90. Later, scan body 80 can be released by unscrewing screw 78 and lifting scan body 80 off abutment 90.

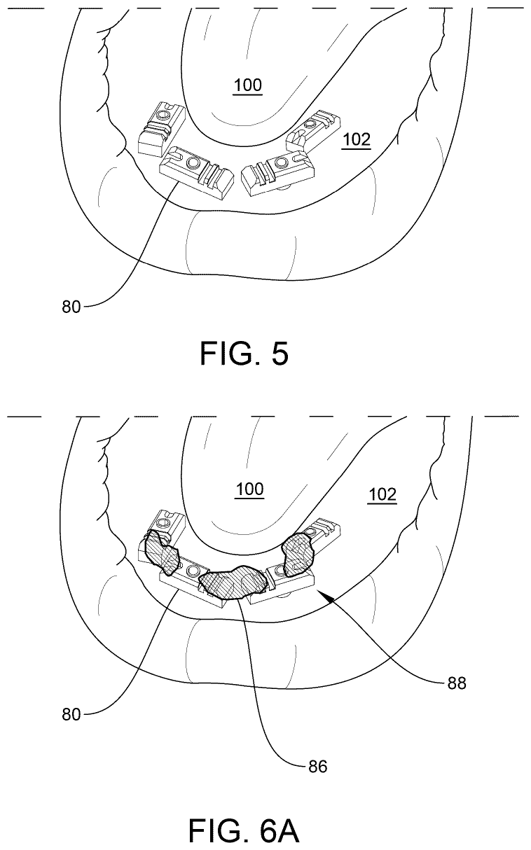

FIG. 5 shows four scan bodies 80 mounted onto their respective abutments that are affixed to the lower jaw 102 of the patient. Intraoral optical scanning is performed to acquire topographic data for the digital model. Note that the rectangular shape and length of scan bodies 80 results in adjacent scan bodies 80 being relatively close to each other. The narrower gaps between scan bodies 80 may be helpful in improving the imaging stitching operation because it can more easily hop from one scan body 80 to the adjacent scan body 80. For anatomical reference, the tongue 100 and lower jaw 102 are also shown here.

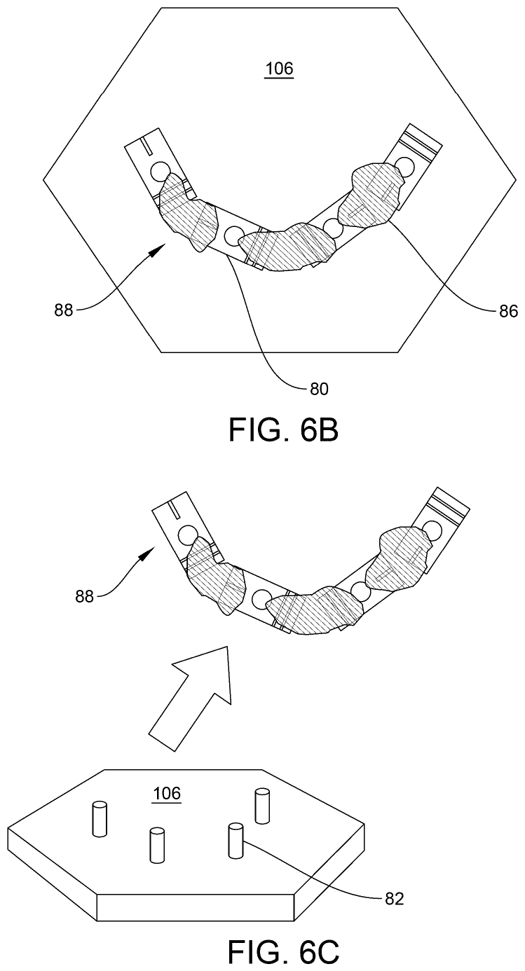

FIGS. 6A-6C demonstrate how the scan body linked assembly 88 is made. As shown in FIG. 6A, after the intraoral scanning is performed, dental resin (e.g. acrylic adhesive) is applied onto scan bodies 80 to link them together. Some of the resin flows into the trenches and notches on scan bodies 80. This improves the resin gripping traction onto scan bodies 80. The resin is cured into hardened patches 86 (e.g. by UV light exposure) that connect scan bodies 80 together. As seen in the figure, the result is three resin patches 86 that link together scan bodies 80, i.e. a linked assembly 88. Resin patches 86 should avoid covering the channel ports.

This linked assembly 88 of scan bodies 80 is removed from the patient's mouth. This is performed by using the driver tool 77 to loosen fastening screws 78 for scan bodies 80. Linked assembly 88 is then taken out of the mouth. See that the narrow gaps between scan bodies 80 also has the benefit of avoiding or lessening deformation of linked assembly 88 that otherwise occurs when the dental resin shrinks during polymerization.

Implant analogs 82 are then inserted through the tool channel of each scan body 80. As shown in FIG. 6B, linked assembly 88 is laid onto freshly-made mixed dental stone 106. Implant analogs 82 carried by scan bodies 80 are buried into the slab of dental stone 106 before it hardens. As shown in FIG. 6C, linked assembly 88 is lifted from stone slab 106. This leaves implant analogs 82 embedded in stone slab 106.

These embedded implant analogs 82 serve as a physical master model. This is sent to the prosthesis fabrication laboratory, along with the digital 3D model. The prosthesis laboratory fabricates the custom prosthesis according to the digital 3D model. The fabricated prosthesis is then mounted onto the physical master model to verify that the custom prosthesis is accurate.

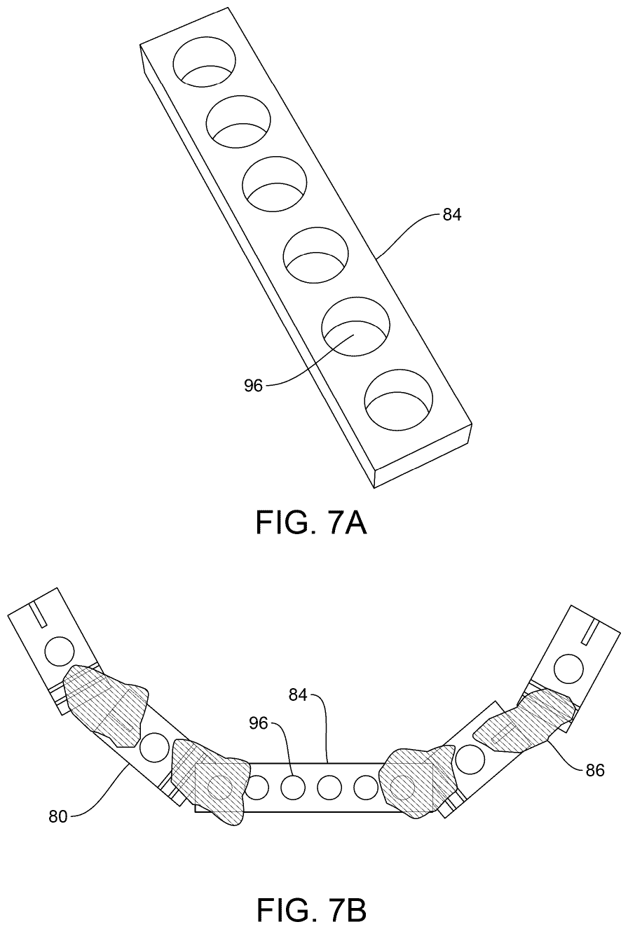

FIGS. 7A and 7B show an example of how a connector beam 84 could be used if there is a wide gap between two adjacent scan bodies because of the implant geometry. FIG. 7A shows a perspective view of an example connector beam 84 made of stainless steel. There are a series of through-holes 96 in the connector beam. FIG. 7B shows an example implant geometry in which there is a wide gap between the middle two scan bodies 80. This wide gap hinders the image stitching process. Thus, connector beam 84 is placed onto the two middle scan bodies 80 and spans the gap between them. Dental resin 86 is applied onto the pieces to hold the connector beam 84. The resin flows into the through-holes 96 of connector beam 84 to increase traction. This could also serve as a linked assembly as described above.

FIG. 8 shows an example of a scan body kit 70 of this invention. Kit 70 includes several scan bodies 80 and several fastener screws 78 for installing scan bodies 80. Kit 70 further includes a driver tool 77 for driving fastener screws 78 in installing scan bodies 80. Kit 70 further includes a syringe 76 containing dental resin to apply the resin patches in making the linked assembly. Kit 70 further includes a pouch 74 containing dental cement for making the master model. Kit 70 further includes a tray 72 into which wet dental cement is poured and the master model is made. Kit 70 further comprises several implant analogs 82. Kit 70 further comprises two connector beams 84 of different lengths. For multiple connector beams 84, having different lengths could be useful to accommodate different implant geometry situations.

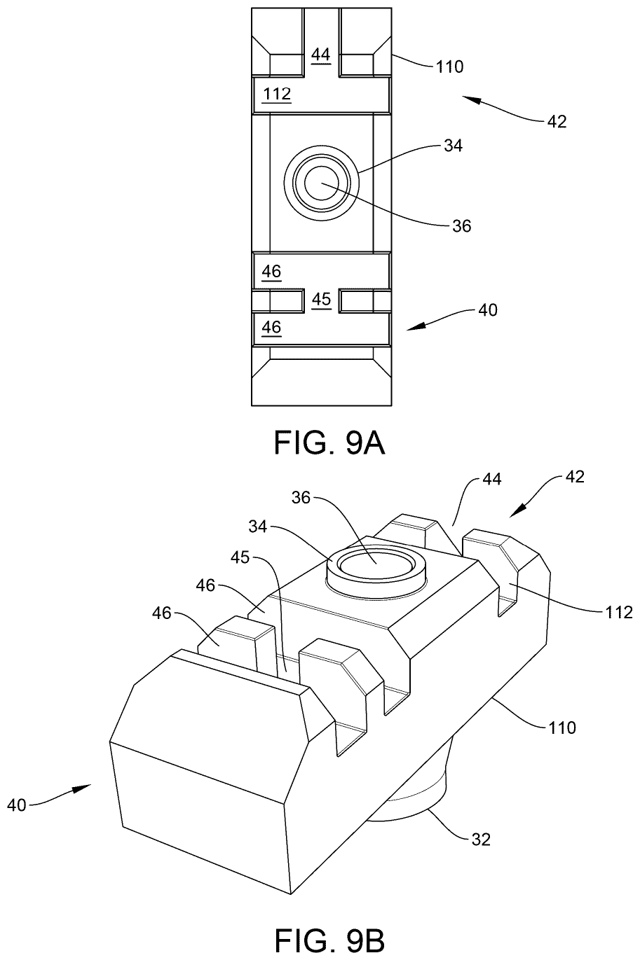

FIGS. 9A (top view) and 9B (perspective view) show another example of a scan body 110. The design of scan body 110 is similar to that of a scan body 80 (see FIGS. 2A-2C). However, scan body 110 has a cross channel 45 between the two trenches 46 at the aft section 40. This creates an “H”-shaped recess on the aft section 40 of scan body 110. Also, at the fore section 42, scan body 110 has an additional trench 112 that intersects notch 44. This creates a “T”-shaped recess on the fore section 42 of scan body 110.

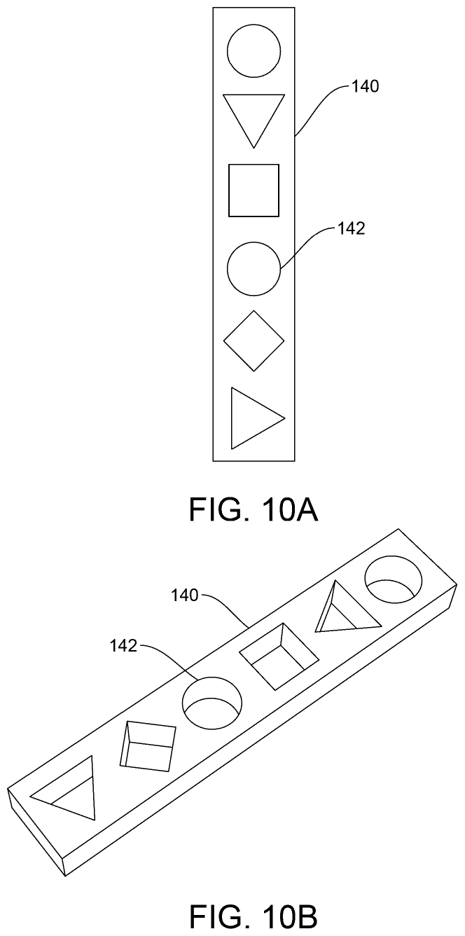

FIGS. 10A (top view) and 10B (perspective view) show another example of a connector beam 140. There are a series of through-holes 142 in connector beam 140. Unlike connector beam 84 (see FIG. 7A), through-holes 142 have multiple different shapes, some in different orientations. Here, there are two circle-shaped holes, two triangle-shaped holes in different orientations, and two square-shaped holes in different orientations. Having these different shape configurations could be useful for increasing feature variation that improves image stitching results.

The terms “first, second, etc.” with respect to elements may be used herein only to distinguish one element from another element. Unless the context indicates otherwise, these are not intended to limit the elements regarding their composition or ordinal arrangement, such as defining the order, position, or priority of the elements. Any use of the word “or” herein is intended to be inclusive and is equivalent to the expression “and/or,” unless the context clearly dictates otherwise. As such, for example, the expression “A or B” means A, or B, or both A and B. Similarly, for example, the expression “A, B, or C” means A, or B, or C, or any combination thereof.

The foregoing description and examples merely illustrate the invention and are not intended to be limiting. Each of the disclosed aspects and embodiments of the invention may be considered individually or in combination with other aspects, embodiments, and variations of the invention. Also, unless otherwise specified, the steps of the methods of the invention are not limited to any particular order of performance. Persons skilled in the art may perceive modifications to these embodiments that incorporate the spirit and substance of the invention. Such modifications are within the scope of the invention.

1. A scan body comprising:
a rectangular block having a substantially rectangular shape, and comprising a fore section and an aft section;
a first recess on the fore section and a second recess on the aft section;
a tool channel in the rectangular block and a channel port at the top of the rectangular block, wherein the channel port partitions the fore section from the aft section;
a base adaptor at the bottom of the rectangular block.

2. The scan body of claim 1, wherein the first recess is a notch that is oriented in a longitudinal direction on the rectangular block.

3. The scan body of claim 1, wherein the second recess is a trench that is oriented in a transverse direction on the rectangular block.

4. The scan body of claim 1, wherein the base adaptor comprises a socket for receiving a mounting platform.

5. The scan body of claim 1, wherein the rectangular block comprises two adjacent trenches at the aft section, wherein the trenches are oriented in a transverse direction and are parallel to each other.

6. The scan body of claim 1, wherein the rectangular block comprises multiple bevel edges at the top surface.

7. The scan body of claim 6, wherein every edge at the top surface perimeter of the rectangular block is a bevel edge.

8. The scan body of claim 4, wherein the tool channel opens into the socket of the base adaptor.

9. The scan body of claim 1, wherein the length of the rectangular block is at least 1.5 times greater than the width.

10. The scan body of claim 9, wherein the length of the rectangular block is at least 10 mm.

11. The scan body of claim 10, wherein height of the rectangular block is in the range of 2-10 mm.

12. A method of performing intraoral scanning on a patient to acquire a digital intraoral topographic impression, comprising:
putting multiple mounting platforms on a jaw of the patient;
having multiple scan bodies that comprise:
(a) a rectangular block having a substantially rectangular shape;
(b) a tool channel in the rectangular block and a channel port at the top of the rectangular block;
(c) a base adaptor at the bottom of the rectangular block;
installing the scan bodies on the mounting platforms;
performing intraoral optical scanning to capture images of the patient's oral cavity including the scan bodies;
creating a digital topographic impression using the captured images.

13. The method of claim 12, wherein the step of installing the scan bodies comprises, for each scan body:
inserting a fastening screw into the tool channel of the scan body;
engaging the base adaptor of the scan body to the mounting platform;
inserting a driver tool into the tool channel;
using the driver tool to fasten the fastening screw to the mounting platform.

14. The method of claim 12, wherein creating the digital topographic impression comprises stitching the captured images together.

15. The method of claim 12, further comprising making a physical master model, comprising:
applying an adhesive resin material to the scan bodies to join the scan bodies into a linked assembly;
removing the linked assembly from the patient's mouth;
inserting implant analogs into each of the tool channels of the scan bodies;
laying the linked assembly onto a plaster slab;
planting the implant analogs into the plaster slab;
removing the linked assembly but leaving the implant analogs planted in the plaster slab.

16. The method of claim 15, wherein the step of removing the linked assembly from the patient's mouth comprises loosening the fastening screws that join the scan bodies to the mounting platforms.

17. The method of claim 12, wherein the mounting platforms are implant abutments.

18. The method of claim 12, wherein the mounting platforms are implant fixtures.

19. A dental scan body kit comprising:
multiple scan bodies that comprise:
(a) a rectangular block having a substantially rectangular shape;
(b) a tool channel in the rectangular block and a channel port at the top of the rectangular block;
(c) a base adaptor at the bottom of the rectangular block;
multiple fastening screws for the scan bodies;
a driver tool for the fastening screws;
a dispenser containing an adhesive resin material;
multiple implant analogs;
a casting setup tray;
a plaster casting material.

20. The kit of claim 19, further comprising a connector beam.
